(19) United States
(12) Patent Application Publication
(10) Pub. No.: US 2011/0115304 A1
(43) Pub. Date: May 19, 2011

(54) POWER SUPPLY STRUCTURE OF PRINTER

(75) Inventors: Feng-Yi Tai, Chung-Ho City (TW); Ta-Cheng Hsiung, Hsinchu City (TW)

(73) Assignee: Godex International Co., Ltd., Chung-Ho City (TW)

(21) Appl. No.: 12/618,777

(22) Filed: Nov. 15, 2009

(51) Int. Cl. H02M 3/06; H02J 7/00

(52) U.S. Cl. 307/109; 320/166

(57) ABSTRACT

A power supply structure of printer has a power supply circuit outputting regular power for printing, and an auxiliary charging circuit having a plurality of farad grade super capacitors collaborated with a voltage-stabilized charging loop to supply power with high transient power and to maintain normal operation of the printer. Given the power structure, the power supply circuit is simplified to reduce the building cost thereof, and the energy waste in operation is effectively lowered, so as to sufficiently provide high transient power and deliver better printing result.

### FIELD OF THE INVENTION

The present invention is related to a power supply structure of printer, and more particularly to an auxiliary power supply structure having farad-grade super capacitor, simplifying power supply structure and reducing cost thereof, effectively lowering energy consumption in operation, and sufficiently providing high transient power.

### BACKGROUND OF THE INVENTION

Printers have many types, such as inkjet printers, laser printers, heat transfer printers, sublimation printers and the like. Recently, keeping abreast with widespread personal computers and booming internet development, printers have become essential peripheral products of latest computers. As far as product appearance and practical functions are concerned, printers are well stocked with all kinds of things. In addition to regular compact printers good for printing demand of various personal documents, professional printers for special purposes are also available to all walks of life.

With reference to FIG. 1, regardless of what types of printers, conventional power circuits all request for high transient power in operation. In other words, large current is required at the instant of printing. Therefore, the systems planned for conventional printers all need to amplify the power of the power circuit by several times beforehand so as to meet the demand of high transient power.

However, flaws of such circuit planning do exist. The trade of upgraded fundamental power supply specification of power circuit for the demand of high transient power simply ends up with higher levels of components adopted internally, making the building cost of the power circuit relatively higher. Besides, more importantly is that such higher standard power supply usually consumes more energy upon power-on and certainly fails to comply with energy-saving and carbon-reducing green environmental protection.

### SUMMARY OF THE INVENTION

The main objective of the present invention is to provide a power supply structure of printer simplifying power supply structure and reducing cost thereof, effectively lowering energy consumption in operation, and sufficiently providing high transient power.

The power supply structure has a power supply circuit and an auxiliary charging circuit.

The power supply circuit outputs regular power for printing. The auxiliary charging circuit has a plurality of farad grade super capacitors collaborated with a voltage-stabilized charging loop to supply high transient power so as to be adapted to maintain normal operation of the printer.

Given the power structure, the power supply circuit is simplified to reduce the building cost thereof, and the energy waste in operation is effectively lowered, so as to sufficiently provide high transient power and deliver better printing result.

The foregoing and other features and advantages of the present invention will be more clearly understood through the following descriptions with reference to the drawing, wherein:

### BRIEF DESCRIPTION OF THE DRAWINGS

FIG. 1 is a schematic view of a conventional power supply structure of printer;

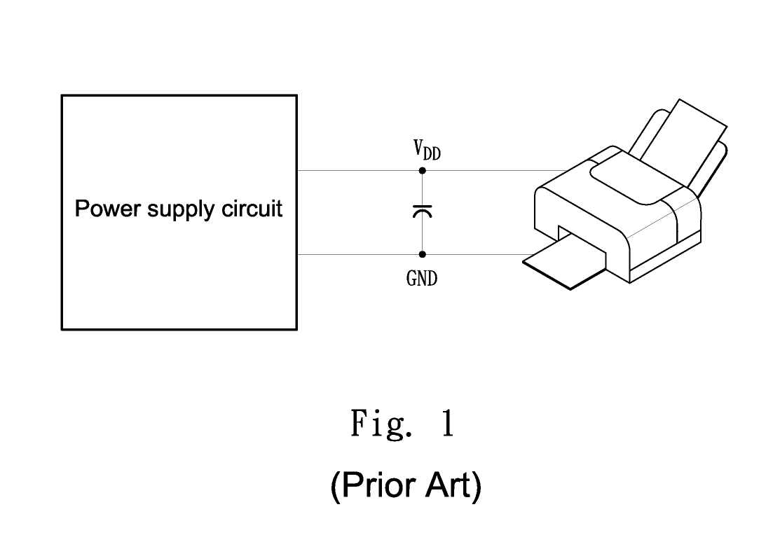

FIG. 2 is a schematic view of a power supply structure of printer in accordance with the present invention;

FIG. 3 is a circuit diagram of an auxiliary power supply circuit in accordance with the present invention;

FIG. 4 is a circuit diagram of a rechargeable battery additionally equipped with an auxiliary charging circuit in accordance with the present invention; and

FIG. 5 is a schematic view of a rechargeable battery serving as a power supply of printer in accordance with the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only; it is not intended to be exhaustive or to be limited to the precise form disclosed.

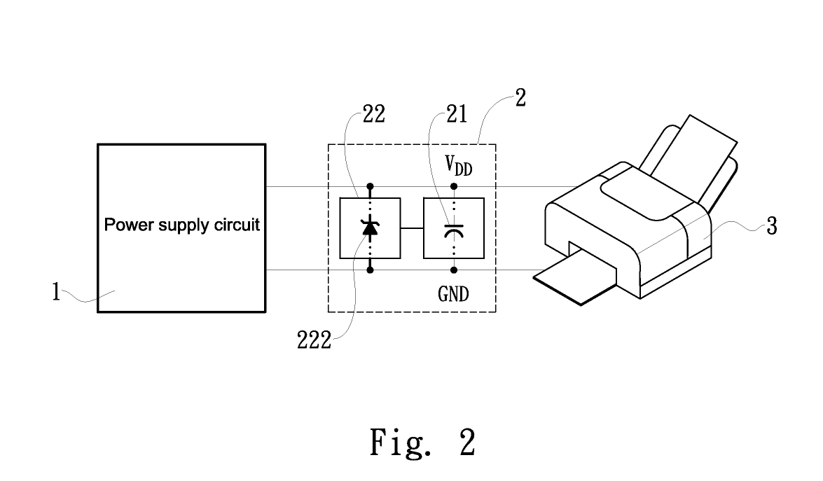

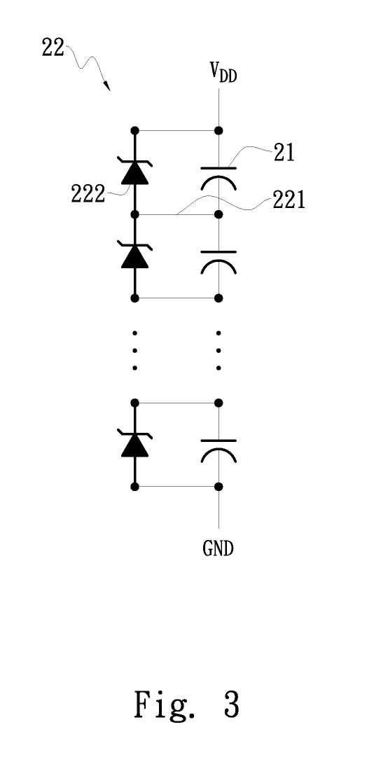

With reference to FIGS. 2 and 3, a power supply of printer in accordance with the present invention has a power supply circuit (1) and an auxiliary charging circuit (2).

The power supply circuit (1) serves to output normal power for regular printing. The auxiliary charging circuit (2) has a plurality of farad-grade super capacitor (21) in collaboration with a voltage-stabilized charging loop (22) to satisfy power consumption requiring high transient power and maintain normal operation of a printer (3).

As a result of the component characteristics of current super capacitors (21), their withstand voltage are not high. Applications shall be serially connected to operate if exceeding the withstand voltage thereof. However, serially-connected operation will incur unbalanced charge and discharge, that is, inconsistent charged or discharged power of each capacitor, and voltage-withstanding issue of individual capacitor. Hence, the auxiliary charging circuit (2) is particularly planned and designed upon implementing to simultaneously solve the voltage-withstanding and unbalanced charging and discharging issues, and is mounted in the form of a plurality of serially-connected layers (221). Each layer (221) is composed of a zener diode (222) and a farad grade super capacitor (21) connected therewith in parallel, and the plurality of super capacitors (21) and zener diodes (222) mounted in the auxiliary charging circuit (2) all pertain to levels with same specification (or same level but with different specifications).

With reference to FIG. 3, the voltage of each zener diode is equal to or smaller than the maximum rated voltage of super capacitor (21), i.e. Vz, <=Vt, and the total voltage of all zener diodes (222) is greater than or equal to the output voltage of the auxiliary charging circuit (2), i.e. n*Vz>=VDD.

Accordingly, the auxiliary charging circuit (2), which is composed of the plurality of zener diodes (21) having farad grade capacity in collaboration with the plurality of zener diodes (222), is connected with an output circuit of a power supply circuit (1) to respond to the high transient power of a printer and address a better printing effect. Normal power for regular printing is outputted by the power supply circuit (1). This makes the output current of the power supply circuit (1) is relatively and noticeably smaller than the conventional circuit. Consequently, relatively lower levels of output specifications are adopted. So, the building cost of the power supply circuit is also lower. Besides, the output current of the power supply circuit (1) becomes smaller, making the power supply circuit (1) more energy-saving than the conventional circuit upon powering on. Printers manufactured by adopting the power supply circuit (1) comply with green environmental protection concepts to be more power-saving and carbon-reducing.

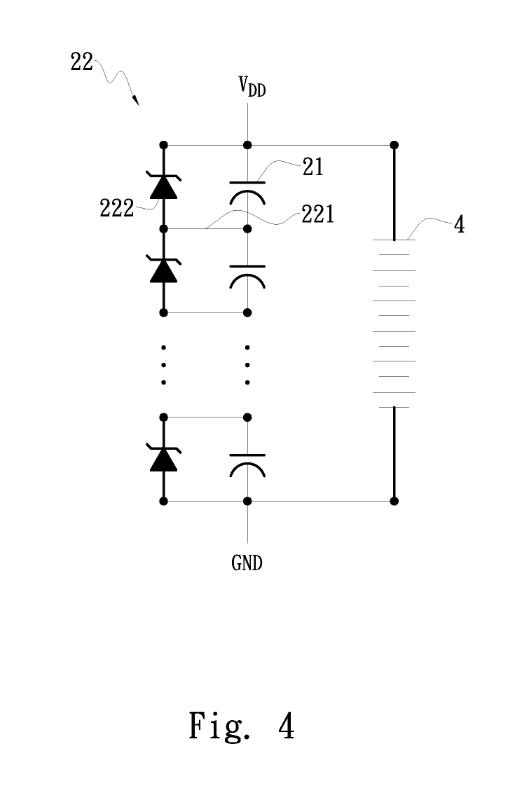

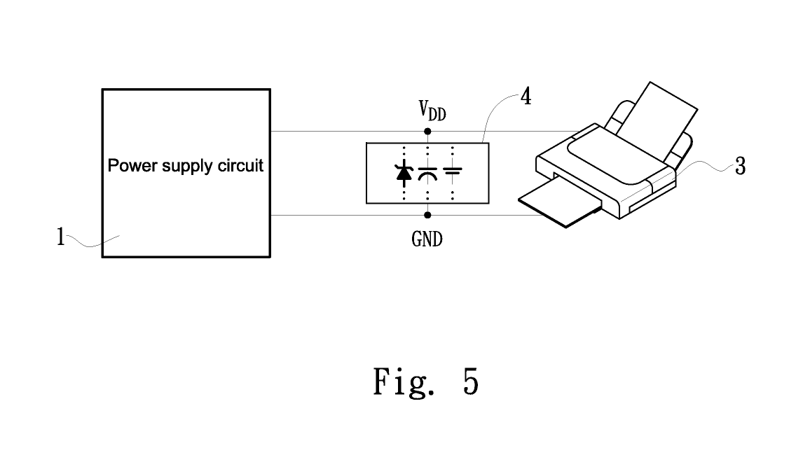

With reference to FIGS. 4 and 5, an auxiliary charging circuit (2) of the present invention can be also adopted to regular power supplied by batteries. In other words, the plurality of serially connected farad grade super capacitors (21) collaborated with the voltage-stabilized charging loop (22) are connected in parallel with a rechargeable battery (4) to supply power to some special portable printers. Likewise, the aforementioned structure is adopted to supply power to a printer (3) having charging power supply. The transient power supply issue of the printer (3) is improved, thereby making the printer (3) operate normally.

In sum, the composition of the present invention is simplified and practical and the function thereof is superior to the conventional power supply structure of printers. The present invention thus provides the practical and innovative value to the industry, and the application is hereby submitted in accordance with the patent laws.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A power supply structure of a printer, comprising:
a power supply circuit outputting regular power for printing; and
an auxiliary charging circuit having a plurality of farad grade super capacitors collaborated with a voltage-stabilized charging loop to supply high transient power so as to be adapted to maintain normal operation of the printer;
whereby a simplified power supply circuit is used to reduce building cost, effectively lower waster of energy and further provide sufficient output demand with high transient power.

2. A power supply structure of a printer, comprising:
a rechargeable battery outputting standardized power for printing; and
an auxiliary charging circuit having a plurality of farad grade super capacitors collaborated with a voltage-stabilized charging loop and electrically connected in parallel with the rechargeable battery to supply power with high transient power and to be adapted to maintain normal operation of the printer;
whereby energy waste is effectively reduced and sufficient output demand with high transient power is provided.

3. The power supply structure as claimed in claim 1, wherein the voltage-stabilized charging loop of the auxiliary charging circuit has a plurality of serially connected layers constituted by a zener diode connected in parallel with one of the plurality of farad grade super capacitors.

4. The power supply structure as claimed in claim 2, wherein the voltage-stabilized charging loop of the auxiliary charging circuit has a plurality of serially connected layers constituted by a zener diode connected in parallel with one of the plurality of farad grade super capacitors.

5. The power supply structure as claimed in claim 3, wherein the auxiliary charging circuit, the plurality of super capacitors and the zener diode pertain to levels with a same specification.

6. The power supply structure as claimed in claim 4, wherein the auxiliary charging circuit, the plurality of super capacitors and the zener diode pertain to levels with a same specification.

7. The power supply structure as claimed in claim 3, wherein the auxiliary charging circuit, the plurality of super capacitors and the zener diode pertain to levels with different specifications.

8. The power supply structure as claimed in claim 4, wherein the auxiliary charging circuit, the plurality of super capacitors and the zener diode pertain to levels with different specifications.
